(19) United States
(12) Patent Application Publication
(10) Pub. No.: US 2004/0112512 A1
(43) Pub. Date: Jun. 17, 2004

(54) Method and structure for forming a paper embossment with a metal foil

(76) Inventor: Hong-Zhen Zhuang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/320,418

(22) Filed: Dec. 17, 2002

(51) Int. Cl. B31F 1/00

(52) U.S. Cl. 156/220; 156/245

(57) ABSTRACT

The present invention relates to a method and structure for forming a paper embossment with a metal foil. A thin PE-layer is bonded between a very thin metal foil and another bottom thin paper. The PE-layer has feature of heating malleability. After the first heating compression, the metal foil is supported against the PE-layer, thereby creating a shallow and thin figure and line. Thereafter, a thicker cardboard is pasted at the bottom of the bottom thin paper. After further heating compression, a structure of deeper and greater embossment is created and supported by the cardboard of better strength so as to produce a detailed embossment effect for decorative patterns.

### BACKGROUND OF THE INVENTION

1. Field of the Invention

The present invention relates to a method and structure for forming a paper embossment with a metal foil, and more particularly, to a method and structure which is able to effectively eliminate the tension effect of paper upon the bonded metal foil. After heating compression for many times, a detailed embossment effect is produced.

2. Description of the Prior Art

For a conventional embossment paper with a metal foil, as shown in FIG. 1, two layers of a flat metal foil 5 and a bottom paper 6 are closely bonded together. The metal foil 5 itself has a better ductility and, therefore, a better forming effect. However, its thickness is very slight and its strength is worse so that it needs the bottom paper 6 to intensify its whole strength. In the processing of embossment, the metal foil 5 and the bottom paper 6 are heat-pressed between a top form 7 and a bottom form 71 with concave and convex patterns. Accordingly, the bonded body of the metal foil 5 and the bottom paper 6 produces an embossment effect.

In order to complete the heating compression procedure, the bottom paper 6 has to be thick enough. However, the bottom paper 6 will create a certain smoothing tension after mold release (see FIG. 2B). Thus, the embossment effect is worsened. Particularly, the finer lines and patterns can't show a better three-dimensional effect due to the paper tension. Accordingly, the formed fine lines and patterns will create a discontinuity state. Even, they could just disappear.

### SUMMARY OF THE INVENTION

It is a primary object of the present invention to eliminate the aforementioned drawbacks and to provide a method and structure for forming a paper embossment with a metal foil. A thin PE-layer is bonded between a very thin metal foil and another bottom thin paper, thereby forming the surface layer. The PE-layer has feature of heating malleability. After the first heating compression, the metal foil is supported against the PE-layer, thereby creating a shallow and thin figure and line. Thereafter, a thicker cardboard (named as base layer) is pasted at the bottom of the bottom thin paper. After the second heating compression, a structure of deeper and greater embossment is created and supported by the cardboard of better strength so as to produce a detailed embossment effect for decorative patterns while the elastic tension of the base layer won't destroy the embossment effect.

It is another object of the present invention to provide a method and structure for forming a paper embossment with a metal foil in which further heating compression procedure can be repeated for forming a more detailed lines and patterns of the embossment part, thereby achieving a more aesthetically appealing appearance.

### BRIEF DESCRIPTION OF THE DRAWINGS

The accomplishment of this and other objects of the invention will become apparent from the following description and its accompanying drawings of which:

FIG. 1 is a sectional view of conventional paper with metal foil;

FIG. 2A is a sectional view of the conventional paper with metal foil after being processed with embossment procedure;

FIG. 2B is a sectional view of the conventional paper with metal foil, showing that the structure is flatted due to the tension of the bottom paper;

FIG. 3 is a flow chart of the forming process of the present invention;

FIG. 4 is a sectional view of the initial structure of the present invention;

FIG. 5 is a sectional view of the initial structure of the present invention after the first heating compression;

FIG. 6 is a sectional view of the whole structure of the present invention; and

FIG. 7 is a sectional view of the whole structure of the present invention after completion of the forming process.

### DETAILED DESCRIPTION OF THE PREFERRED EMBODIMENT

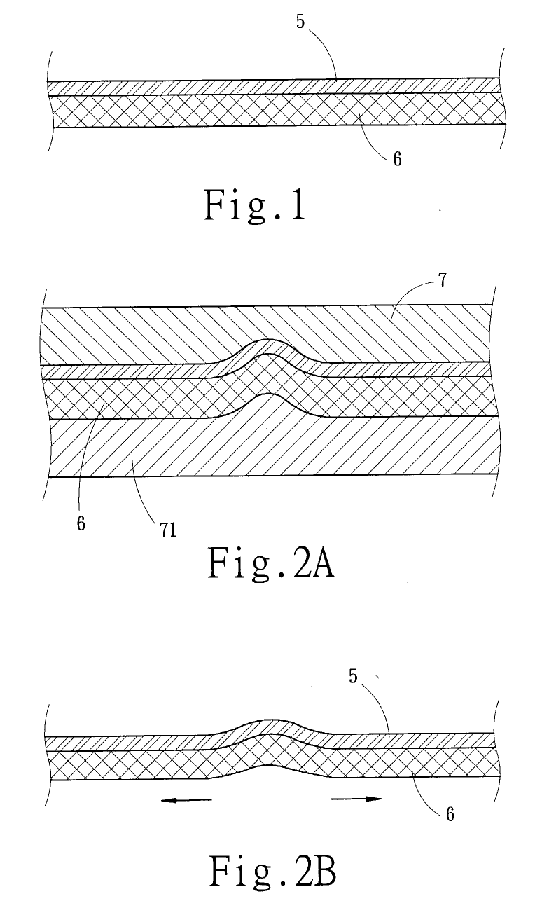

FIG. 1 shows a sectional view of conventional paper with metal foil. FIGS. 2 show sectional views of conventional paper with metal foil after forming process and being flatted. The configuration and drawbacks have been described above so that no further descriptions are given hereinafter.

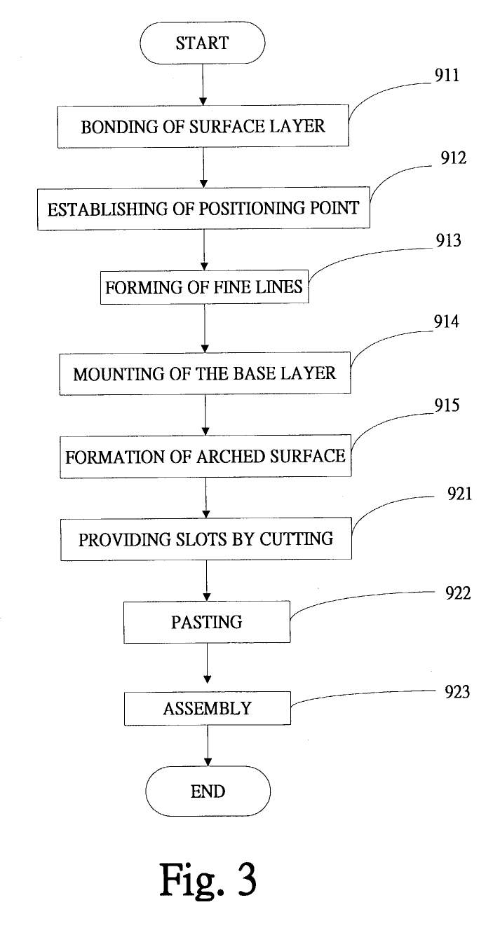

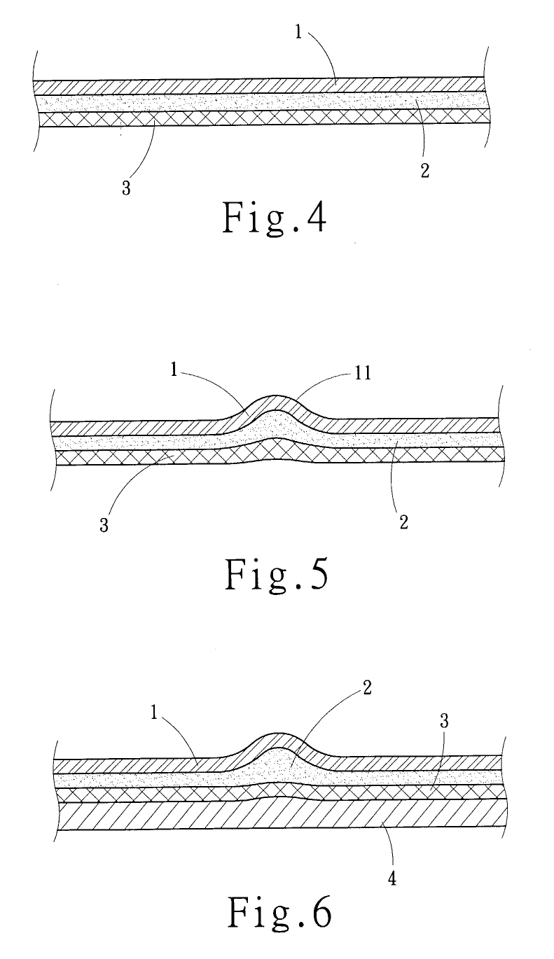

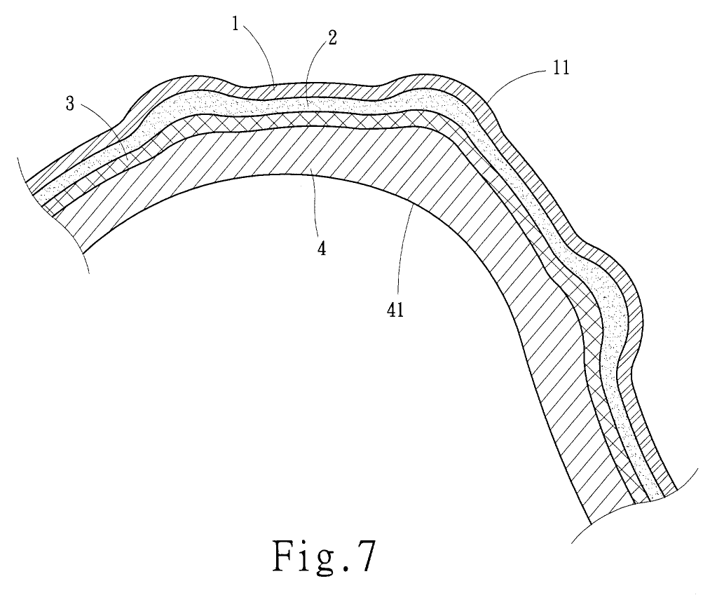

FIG. 3 shows a flow chart of the forming process of the present invention. Also, referring to FIG. 4 through 7, structural sectional views of every processing procedure are shown. In the initial step of “bonding of the base layer” 911, the PE-layer 2 is interposed and pasted between the thin metal foil 1 and a bottom paper 3 with normal paper thickness (see FIG. 4), thereby forming a surface layer. If required, the metal foil 1 can be printed with proper figures or patterns first. The thickness of the PE-layer 2 preferably amounts to 0.15 mm. The bonding body (surface layer) of the metal foil 1, the PE-layer 2 and the bottom paper 3 is processed with a step of “establishing of positioning points” 912 to create a plurality of reference points for positioning. In the step of “forming of fine lines” 913, the reference points are directed pressed and heated by a mold with concave and convex patterns. After being heated, the PE-layer 2 has the feature of ductility, thereby creating accumulation or compression to force the metal foil 1 at the top thereof to produce concave and convex fine lines and patterns 11. Here, the bottom paper 3 at the bottom of the PE-layer 2 creates the elastic tension to compel itself in flat state without affecting the formation of the fine lines and patterns 11 on the surface of the metal foil 1 (see FIG. 5). After formation of the fine lines and patterns 11, the base layer 4 (i.e. cardboard, see FIG. 6) is mounted to the bottom of the paper 3 in the step of “mounting the base layer” 914 for intensifying the strength of the whole structure. The bottom of the bottom paper 3 is flatter than the surface of the metal foil 1 so that a better bonding between the bottom paper 3 and the base layer 4 can be achieved. In the step of “formation of arched surface” 915, the same reference points for positioning are pressed and heated by one or different molds with greater height difference of the concave and convex part for at least one time, thereby creating an arched surface 41 with greater concave-convex change. Accordingly, the fine lines and patterns 11 are well-distributed on the arched surface 41 in accordance with expected design to form a multi-layer arrangement effect (see FIG. 7).

In practice, the paper structure formed through the above-mentioned steps can be processed with another step of “providing a plurality of slots by cutting” 921 at the rim thereof. Furthermore, a cardboard in proper shape is pasted to the back side thereof in the step of “pasting” 922. Meanwhile, the part with slots is bent to wrap around the cardboard so as to form semi-finished product with proper strength and embossment patterns. Finally, the semi-finished product is processed with a step of “assembly” 923 to complete a desired finished product. For example, the semi-finished product is provided with a ring-shaped rim so as to create a case or cover body.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A method for forming a paper embossment with a metal foil, comprising:
bonding a metal foil, a PE-layer and a bottom paper one after another together to form a surface layer;
establishing a plurality of positioning points to be reference points;
pressing and heating said reference points by a mold with concave and convex patterns so that said PE-layer is softened after heating and, therefore, ductile to squeeze against the surface of said metal foil at the top of said metal foil;
pasting a base layer to the bottom side of said bottom paper for intensifying the whole structural strength; and
pressing and heating said reference points by one mold with greater height difference of the concave and convex part for at least one time so as to create an arched surface with greater concave-convex change.

2. The method for forming a paper embossment with a metal foil as claimed in claim 1, wherein different molds can be employed one after another to enable said fine lines and patterns with different height difference of the concave and convex parts to distribute on said arched surface so as to form a multi-layer pattern arrangement effect.

3. The method for forming a paper embossment with a metal foil as claimed in claim 1 or 2, wherein the surface of said metal foil is printed with proper figures or patterns after bonding said metal foil, said PE-layer and said bottom paper together.

4. A structure for forming a paper embossment with a metal foil, at least comprising:
a surface layer formed by a metal foil, a PE-layer and a bottom paper three of which are bonded together one after another so that finer concave and convex lines and patterns are created by squeezing said metal foil after said PE-layer is heated and pressed by a mold; and
a base layer pasted to the bottom side of said bottom paper of said surface layer for intensifying the whole structural strength, wherein an arched surface with greater concave-convex change is formed to achieve a detailed embossment pattern effect after said surface layer and said base layer are bonded together.

5. The structure for forming a paper embossment with a metal foil as claimed in claim 4, wherein the surface of said metal foil is printed with proper figures or patterns.

6. The structure for forming a paper embossment with a metal foil as claimed in claim 4 or 5, wherein the thickness of said PE-layer preferably amounts to 0.15 mm.

7. The structure for forming a paper embossment with a metal foil as claimed in claim 4 or 5, wherein said base layer is made up of cardboard.

8. The structure for forming a paper embossment with a metal foil as claimed in claim 6, wherein said base layer is made up of cardboard.
